(19) United States
(12) Patent Application Publication
(10) Pub. No.: US 2026/0035038 A1
(43) Pub. Date: Feb. 5, 2026

(54) A VEHICLE STRUCTURE

(71) Applicant: AUTOTECH ENGINEERING S.L., Amorebieta-Etxano, Bizkaia (ES)

(72) Inventors: Sergi MARQUEZ DURAN, Rajadell, Barcelona (ES); Guillermo LINARES CAYERO, Rubí (ES); Carlos Manuel RUIZ RUIZ, Martorell (ES)

(73) Assignee: AUTOTECH ENGINEERING S.L., Amorebieta-Etxano, Bizkaia (ES)

(21) Appl. No.: 19/099,926

(22) PCT Filed: Sep. 4, 2023
(86) PCT No.: PCT/EP2023/074197

§ 371 Date: Jan. 30, 2025

(30) Foreign Application Priority Data
Sep. 8, 2022 (EP) 22382834.4

(51) Int. Cl. B62D 21/15; B62D 21/02

(52) U.S. Cl. CPC B62D 21/15; B62D 21/02

(57) ABSTRACT

A vehicle structure comprising a portion including first and second members forming a closed space. The portion comprises one or more tubular reinforcement members located in the closed space. The tubular reinforcement member is corrugated. The tubular reinforcement member comprises two or more member sections positioned after one another in the longitudinal direction. One of the member sections bulges outward in a first direction and in a second direction opposite to the first direction and bulges inward in a third direction, the third direction being transverse to the first and second directions, while another one of the member sections, which adjoins said one of the member sections, bulges inward in the first and second directions and bulges outward in the third direction.

### TECHNICAL FIELD

Aspects of the present invention relate to a vehicle structure comprising a portion having a longitudinal extension extending in a longitudinal direction. The portion comprises a first member having a longitudinal extension extending in the longitudinal direction and a second member having a longitudinal extension extending in the longitudinal direction. The first and second members are attached to one another such that the first and second members form a closed space.

### BACKGROUND OF THE INVENTION

In the design of a frame portion of a motor vehicle, there is a compromise between weight and strength. For example, an advantageous manner of obtaining a good compromise is to produce a frame portion from one or more metal plates or metal alloy plates formed into a requested shape, e.g. a hat profile.

In general, a frame portion of a motor vehicle is formed to have a certain rigidity since it may receive various impacts from the outside. At the same time, some frame portions should allow deformation for absorbing impacts when receiving an overload, e.g. due to a collision with an external object, e.g. another vehicle or a stationary object, e.g. a tree etc. One example of a vehicle frame portion that should be allowed to deform for absorbing impacts while being rigid is the vehicle side sill structure, or the bumper or bumper beam.

### SUMMARY OF THE INVENTION

The inventors of the present invention have found drawbacks in conventional vehicle frame portions, for example as discussed above. For example, some conventional solutions do not provide a sufficient deformation for absorbing impacts while being sufficiently rigid. For example, some conventional vehicle frame portions are complicated to produce.

An object of the invention is to provide a solution which mitigates or solves drawbacks and problems of conventional solutions.

The above and further objects are solved by the subject matter of the independent claims. Further advantageous embodiments of the invention can be found in the dependent claims.

According to a first aspect of the invention, the above mentioned and other objects are achieved with a vehicle structure comprising a portion having a longitudinal extension extending in a longitudinal direction, wherein the portion comprises
a first member having a longitudinal extension extending in the longitudinal direction, and
a second member having a longitudinal extension extending in the longitudinal direction,
wherein the first member is configured to face an inside of a vehicle,
wherein the second member is configured to face an outside of the vehicle,
wherein the first and second members are attached to one another such that the first and second members form a closed space,
wherein the portion comprises one or more tubular reinforcement members located in the closed space,
wherein the tubular reinforcement member has a longitudinal extension extending in the longitudinal direction,
wherein the tubular reinforcement member is corrugated and comprises corrugations,
wherein the tubular reinforcement member comprises two or more member sections positioned after one another in the longitudinal direction, and
wherein one of the member sections bulges outward in a first direction and in a second direction opposite to the first direction and bulges inward in a third direction, the third direction being transverse to the first and second directions, while another one of the member sections, which adjoins said one of the member sections, bulges inward in the first and second directions and bulges outward in the third direction.

By way of the innovative configuration of the tubular reinforcement member, the corrugated tubular reinforcement member may be described to have, or form, two or more wave shapes that are not in phase with one another but instead shifted in relation to one another in the longitudinal direction, or in the direction of the longitudinal extension of the tubular reinforcement member. The two or more wave shapes may be described to provide a zig-zag (or alternating) structure or appearance of the corrugated tubular reinforcement member and/or of the member sections adjoining one another, i.e., when one longitudinal side of the tubular reinforcement member bulges outward at a cross-section somewhere at the longitudinal extension of the tubular reinforcement member another longitudinal side of the tubular reinforcement member bulges inward at the same cross-section, and at a subsequent cross-section in the longitudinal direction it is the other way around.

An advantage of the vehicle structure according to the first aspect of the invention is that an advantageous deformation of the vehicle structure for absorbing impacts is provided while maintaining or improving the rigidity and reinforcement of the vehicle structure in order to prevent penetration upon collisions, for example lateral or side collisions. An advantage of the vehicle structure according to the first aspect of the invention is that the kinematic and load distribution of the vehicle structure can be efficiently controlled upon collisions, i.e. the way the vehicle structure deforms and/or collapses upon collisions can be efficiently controlled. An advantage of the vehicle structure according to the first aspect of the invention is that the energy absorption by the vehicle structure upon collisions is improved, for example that the vehicle structure provides a high energy absorption upon a collision while still being sufficiently rigid and reinforced to prevent the intrusion of an external object into the car upon a collision.

An advantage of the vehicle structure according to the first aspect of the invention is that the process of producing the tubular reinforcement member is facilitated in relation to conventional solutions. An advantage of the vehicle structure according to the first aspect of the invention is that the process of assembling the vehicle structure is facilitated, for example in relation to conventional solutions including tubular reinforcement members having a circular cross-section. For example, the tubular reinforcement member of the vehicle structure according to the first aspect is less bulky and thus provides less bulky vehicle structures but with a sufficient strength and a sufficient prevention against intrusion of an external object into the car upon a collision in relation to conventional tubular reinforcement members having a circular cross-section and conventional solutions including such conventional tubular reinforcement members.

An advantage of the vehicle structure according to the first aspect of the invention is that the weight and cost of the vehicle structure can be reduced while still maintaining or even improving the rigidity and reinforcement of the vehicle structure. An advantage of the vehicle structure according to the first aspect of the invention is that the performance of the vehicle structure in collisions is improved, for example because the vehicle structure can be deformed in a more controlled and more predicted manner, whereby an improved vehicle structure is provided.

The vehicle structure may be a vehicle structure for a motor vehicle with a combustion engine, an electric vehicle having one or more electric batteries or a hybrid vehicle. For example, the vehicle may be a car or a truck. The vehicle structure may be configured to protect an electric battery of an electric vehicle or a hybrid vehicle, for example upon a collision. The vehicle structure may be located at one or more sides of an electric battery located in a vehicle. The vehicle structure is efficient in protecting the electric battery, the driver and/or one or more passengers of the vehicle upon a collision.

The vehicle structure is efficient as a protection with regard to pole collisions or crashes. The vehicle structure is efficient in preventing the intrusion of a pole into the car upon a pole collision. Thus, the vehicle structure provides an efficient intrusion resistance, i.e. the vehicle structure is efficient in preventing the intrusion of an external object into the car upon a collision. This is an important aspect with regard to electric battery protection.

A “closed space” mentioned above also includes spaces which are substantially or essentially closed. For example, there may one or more minor openings in the walls forming the closed space and/or at the ends of the portion of the vehicle structure.

According to an advantageous embodiment of the vehicle structure according to the first aspect, the tubular reinforcement member comprises one or more flat regions extending along the entire longitudinal extension of the tubular reinforcement member. An advantage of this embodiment is that the process of producing the tubular reinforcement member is further facilitated. An advantage of this embodiment is that the process of assembling the vehicle structure is further facilitated, for example in relation to conventional solutions including tubular reinforcement members having a circular cross-section. For example, the flat region may be used for an efficient attachment of the tubular reinforcement member to one of the first and second members. An advantage of this embodiment is that the tubular reinforcement member is even less bulky and thus provides even less bulky vehicle structures but with a sufficient strength and a sufficient prevention against intrusion of an external object into the car upon a collision. An advantage of this embodiment is that a further improved vehicle structure is provided.

According to a further advantageous embodiment of the vehicle structure according to the first aspect, one of the member sections bulges outward and inward in the first and second directions and bulges inward in the third direction while another one of the member sections, which adjoins said one of the member sections, bulges inward and outward in the first and second directions and bulges outward in the third direction. An advantage of this embodiment is that the process of producing the tubular reinforcement member is further facilitated, inter alia, because the tubular reinforcement member may be easily positioned in the die when forming the tubular reinforcement member. An advantage of this embodiment is that the performance of the vehicle structure in collisions can be more efficiently tailored, and thus, the vehicle structure can be deformed in an even more controlled and more predicted manner. An advantage of this embodiment is that a further improved vehicle structure is provided.

According to another advantageous embodiment of the vehicle structure according to the first aspect, one of the member sections bulges outward in the first and second directions and bulges inward in the third direction and in a fourth direction opposite to the third direction while another one of the member sections, which adjoins said one of the member sections, bulges inward in the first and second directions and bulges outward in the third and fourth directions. An advantage of this embodiment is that the performance of the vehicle structure in collisions can be even more efficiently tailored, and thus, the vehicle structure can be deformed in an even more controlled and more predicted manner. An advantage of this embodiment is that the performance of the vehicle structure in collisions is further improved. An advantage of this embodiment is that a further improved vehicle structure is provided.

According to still another advantageous embodiment of the vehicle structure according to the first aspect, the corrugations of the tubular reinforcement member comprise annular ridges, wherein said one of the member sections and said other one of the member sections, which bulge outward and inward, together comprise one and the same annular ridge of the annular ridges. An advantage of this embodiment is that the deformation of the vehicle structure for absorbing impacts is further improved while maintaining or improving the rigidity and reinforcement of the vehicle structure. An advantage of this embodiment is that the performance of the vehicle structure in collisions is further improved. An advantage of this embodiment is that a further improved vehicle structure is provided.

According to yet another advantageous embodiment of the vehicle structure according to the first aspect, the annular ridge at least partially extends transversely to the longitudinal direction. An advantage of this embodiment is that the deformation of the vehicle structure for absorbing impacts is further improved while maintaining or improving the rigidity and reinforcement of the vehicle structure. An advantage of this embodiment is that the performance of the vehicle structure in collisions is further improved. An advantage of this embodiment is that a further improved vehicle structure is provided.

According to an advantageous embodiment of the vehicle structure according to the first aspect, the corrugations of the tubular reinforcement member comprise annular grooves, wherein said one of the member sections and said other one of the member sections, which bulge outward and inward, together comprise one and the same annular groove of the annular grooves. An advantage of this embodiment is that the deformation of the vehicle structure for absorbing impacts is further improved while maintaining or improving the rigidity and reinforcement of the vehicle structure. An advantage of this embodiment is that the performance of the vehicle structure in collisions is further improved. An advantage of this embodiment is that a further improved vehicle structure is provided.

According to a further advantageous embodiment of the vehicle structure according to the first aspect, the annular groove at least partially extends transversely to the longitudinal direction. An advantage of this embodiment is that the deformation of the vehicle structure for absorbing impacts is further improved while maintaining or improving the rigidity and reinforcement of the vehicle structure. An advantage of this embodiment is that the performance of the vehicle structure in collisions is further improved. An advantage of this embodiment is that a further improved vehicle structure is provided.

According to another advantageous embodiment of the vehicle structure according to the first aspect, the annular ridges and the annular grooves form one or more wave shapes extending along the longitudinal extension of the tubular reinforcement member in the longitudinal direction. An advantage of this embodiment is that the deformation of the vehicle structure for absorbing impacts is further improved while maintaining or improving the rigidity and reinforcement of the vehicle structure. An advantage of this embodiment is that the performance of the vehicle structure in collisions is further improved. An advantage of this embodiment is that a further improved vehicle structure is provided.

According to yet another advantageous embodiment of the vehicle structure according to the first aspect, the annular ridges and the annular grooves form the tubular reinforcement member. An advantage of this embodiment is that the deformation of the vehicle structure for absorbing impacts is further improved while maintaining or improving the rigidity and reinforcement of the vehicle structure. An advantage of this embodiment is that the performance of the vehicle structure in collisions is further improved. An advantage of this embodiment is that a further improved vehicle structure is provided.

According to still another advantageous embodiment of the vehicle structure according to the first aspect, one of the member sections bulges outward and inward in the first and second directions and bulges inward in the third and fourth directions while another one of the member sections, which adjoins said one of the member sections, bulges inward and outward in the first and second directions and bulges outward in the third and fourth directions. An advantage of this embodiment is that the process of producing the tubular reinforcement member is further facilitated. An advantage of this embodiment is that the performance of the vehicle structure in collisions can be more efficiently tailored, and thus, the vehicle structure can be deformed in an even more controlled and more predicted manner. An advantage of this embodiment is that a further improved vehicle structure is provided.

According to an advantageous embodiment of the vehicle structure according to the first aspect, the tubular reinforcement member comprises one or more flat regions for the attachment of the tubular reinforcement member to one or more of the first and second members. An advantage of this embodiment is that the process of assembling the vehicle structure is further facilitated, since the tubular reinforcement member can be easily attached to one or more of the first and second members at the flat region, for example without any additional brackets. An advantage of this embodiment is that a further improved vehicle structure is provided.

According to a further advantageous embodiment of the vehicle structure according to the first aspect, the member sections form one or more wave shapes extending along the longitudinal extension of the tubular reinforcement member in the longitudinal direction. An advantage of this embodiment is that the deformation of the vehicle structure for absorbing impacts is further improved while maintaining or improving the rigidity and reinforcement of the vehicle structure. An advantage of this embodiment is that the performance of the vehicle structure in collisions is further improved. An advantage of this embodiment is that a further improved vehicle structure is provided.

According to another advantageous embodiment of the vehicle structure according to the first aspect, the member sections form the tubular reinforcement member. An advantage of this embodiment is that the deformation of the vehicle structure for absorbing impacts is further improved while maintaining or improving the rigidity and reinforcement of the vehicle structure. An advantage of this embodiment is that the performance of the vehicle structure in collisions is further improved. An advantage of this embodiment is that a further improved vehicle structure is provided.

According to yet another advantageous embodiment of the vehicle structure according to the first aspect, the tubular reinforcement member forms one or more openings for welding so as to attach the tubular reinforcement member to one or more of the first and second members. An advantage of this embodiment is that the process of assembling the vehicle structure is further facilitated. An advantage of this embodiment is that a further improved vehicle structure is provided.

According to still another advantageous embodiment of the vehicle structure according to the first aspect, the tubular reinforcement member is hydroformed, hot gas formed, extruded, or formed from one or more plates. This is an efficient way to produce the tubular reinforcement member.

According to an advantageous embodiment of the vehicle structure according to the first aspect, the tubular reinforcement member is made of a material comprising or consisting of a metal or a metal alloy. This is an efficient way to produce a strong tubular reinforcement member.

According to a further advantageous embodiment of the vehicle structure according to the first aspect, one or more of the first and second members is/are formed from a plate. This is an efficient way to produce the first and second members.

According to an advantageous embodiment of the vehicle structure according to the first aspect, one or more of the first and second members is/are formed from one or more plates by way of hot press forming, or formed from one or more plates by way of cold working. This is an efficient way to produce the first and second members.

According to another advantageous embodiment of the vehicle structure according to the first aspect, one or more of the first and second members is/are made of a material comprising or consisting of a metal or a metal alloy. This is an efficient way to produce strong first and second members.

According to still another advantageous embodiment of the vehicle structure according to the first aspect, one or more of the first and second members comprises/comprise one of the group of:
a hat profile; and
a U-profile.

This is an efficient way to produce the first and second members and provide the closed space.

According to yet another advantageous embodiment of the vehicle structure according to the first aspect, the vehicle structure is a vehicle side structure, wherein the portion is a side portion. The vehicle structure is suitable to be applied as a vehicle side structure of a vehicle, whereby the performance of a vehicle side structure in lateral or side collisions is improved. Thus, an improved vehicle side structure is provided. However, in alternative embodiments, the vehicle structure may be applied and mounted elsewhere to the vehicle, for example in the front of the vehicle, and may there be part of a bumper, in the rear of the vehicle, or elsewhere within the vehicle.

According to still another advantageous embodiment of the vehicle structure according to the first aspect, the portion is a side sill portion, wherein the longitudinal extension of the side sill portion is configured to extend in a longitudinal direction of a vehicle body of the vehicle and is configured to be provided at a side of the vehicle body. An advantage of this embodiment is that an advantageous deformation of the vehicle structure having a side sill portion for absorbing impacts is provided while maintaining or improving the rigidity and reinforcement of a vehicle structure. The innovative first reinforcement member is especially advantageous for a side sill portion of the vehicle structure, where impacts should be absorbed upon certain collisions. However, in alternative embodiments, instead of a side sill portion, the portion or the side portion may be a side beam portion, a bumper portion, or a beam portion configured to be located elsewhere in a vehicle.

According to an advantageous embodiment of the vehicle structure according to the first aspect, the side sill portion is configured to be attached to one or more cross beams of the vehicle body. Hereby, the rigidity of the vehicle structure may be further improved.

The above-mentioned features and embodiments of the vehicle structure may be combined in various possible ways providing further advantageous embodiments.

According to a second aspect of the invention, the above mentioned and other objects are achieved with method for producing a vehicle structure comprising a portion having a longitudinal extension extending in a longitudinal direction, wherein the portion comprises
a first member having a longitudinal extension extending in the longitudinal direction, and
a second member having a longitudinal extension extending in the longitudinal direction,
wherein the first member is configured to face an inside of a vehicle,
wherein the second member is configured to face an outside of the vehicle,
wherein the first and second members are attached to one another such that the first and second members form a closed space,
wherein the method comprises:
producing one or more tubular reinforcement members by way of one of hydroforming and hot gas forming; and
placing the one or more tubular reinforcement members in the closed space.

An advantage of the method according to the second aspect is that the process of producing the tubular reinforcement member is facilitated in relation to conventional solutions. Consequently, an advantage of the method according to the second aspect is that the process of producing the vehicle structure including the tubular reinforcement member is facilitated. An advantage of the method according to the second aspect is that the weight and/or cost of the vehicle structure can be reduced while still maintaining or even improving the rigidity and reinforcement of the vehicle structure.

Further advantageous embodiments of the vehicle structure according to the first aspect and of the method according to the second aspect and further advantages with the embodiments of the present invention emerge from the dependent claims and the detailed description of embodiments.

### BRIEF DESCRIPTION OF THE DRAWINGS

The present invention will now be described, for exemplary purposes, in more detail by way of embodiments and with reference to the enclosed drawings, where similar references are used for similar parts, in which:

FIG. 1 is a schematic top perspective view of the tubular reinforcement member of a first embodiment of the vehicle structure according to the first aspect of the invention;

FIG. 2 is another schematic top perspective view of the tubular reinforcement member of FIG. 1;

FIG. 3 is a schematic side view of the tubular reinforcement member of FIG. 1;

FIG. 4 is another schematic side view of the tubular reinforcement member of FIG. 1;

FIG. 5 is a schematic top view of the tubular reinforcement member of FIG. 1;

FIG. 6 is a schematic bottom view of the tubular reinforcement member of FIG. 1;

FIG. 7 is a cross-section view of the tubular reinforcement member of FIG. 3 along A-A;

FIG. 8 is a schematic exploded perspective view of a first embodiment of the vehicle structure according to the first aspect of the invention;

FIG. 9 is a cross-section view of the assembled vehicle structure of FIG. 8;

FIG. 10 is a partial side view of the tubular reinforcement member of FIGS. 4 and 8 located in the closed space illustrating a plurality of planes for the cross-section views of FIGS. 11 to 13;

FIG. 11 is a cross-section view of the assembled vehicle structure of FIG. 8 along D-D in FIG. 10;

FIG. 12 is a cross-section view of the assembled vehicle structure of FIG. 8 along E-E in FIG. 10;

FIG. 13 is a cross-section view of the assembled vehicle structure of FIG. 8 along F-Fin FIG. 10;

FIG. 14 is a cross-section view of the assembled vehicle structure of FIG. 8 along G-G in FIG. 10;

FIG. 15 is a schematic top perspective view of the tubular reinforcement member of a second embodiment of the vehicle structure according to the first aspect of the invention;

FIG. 16 is another schematic top perspective view of the tubular reinforcement member of FIG. 15;

FIG. 17 is a schematic side view of the tubular reinforcement member of FIG. 15;

FIG. 18 is another schematic side view of the tubular reinforcement member of FIG. 15;

FIG. 19 is a schematic top view of the tubular reinforcement member of FIG. 15;

FIG. 20 is a schematic bottom view of the tubular reinforcement member of FIG. 15;

FIG. 21 is a cross-section view of the tubular reinforcement member of FIG. 17 along B-B;

FIG. 22 is a schematic exploded perspective view of a first embodiment of the vehicle structure according to the first aspect of the invention;

FIG. 23 is a cross-section view of the assembled vehicle structure of FIG. 22;

FIG. 24 is a partial side view of the tubular reinforcement member of FIGS. 18 and 22 located in the closed space illustrating a plurality of planes for the cross-section views of FIGS. 25 to 28;

FIG. 25 is a cross-section view of the assembled vehicle structure of FIG. 22 along D-D in FIG. 24;

FIG. 26 is a cross-section view of the assembled vehicle structure of FIG. 22 along E-E in FIG. 24;

FIG. 27 is a cross-section view of the assembled vehicle structure of FIG. 22 along F-F in FIG. 24;

FIG. 28 is a cross-section view of the assembled vehicle structure of FIG. 22 along G-G in FIG. 24; and

FIG. 29 is a schematic flow chart illustrating aspects of embodiments of the method according to the second aspect of the invention.

### DETAILED DESCRIPTION

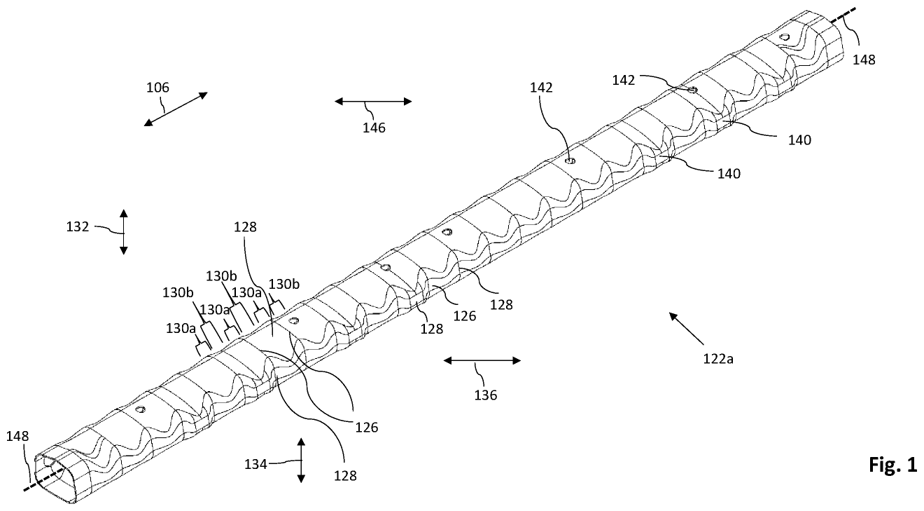

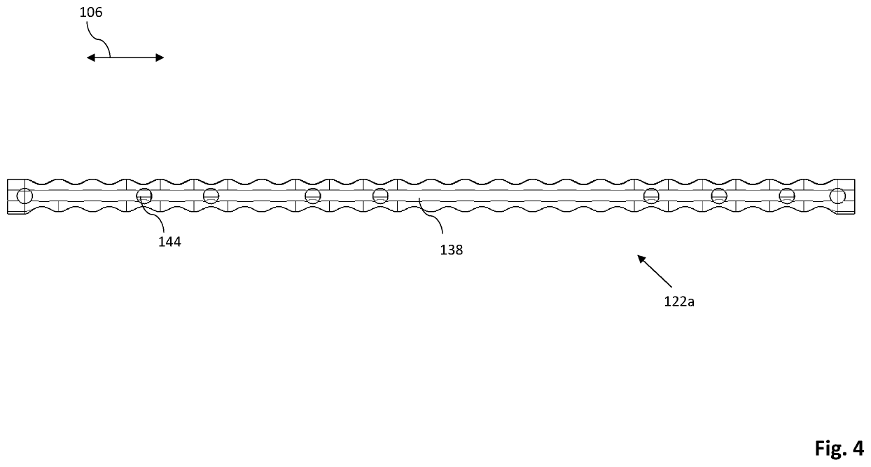

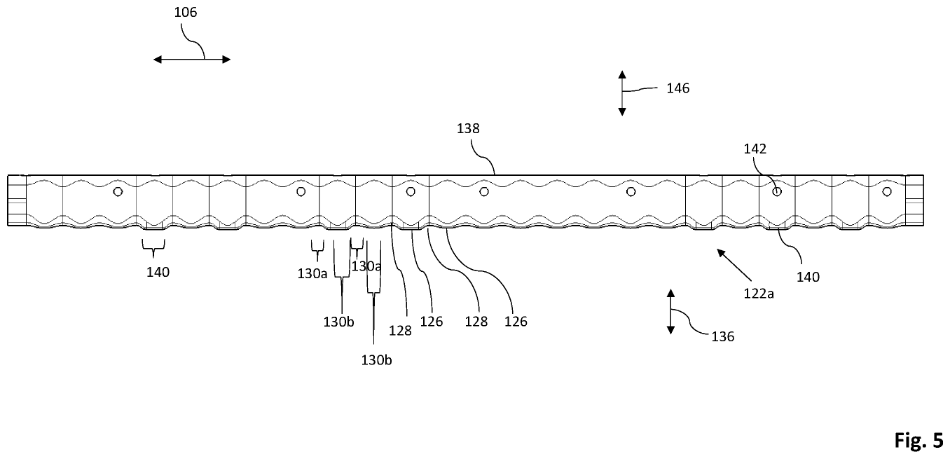

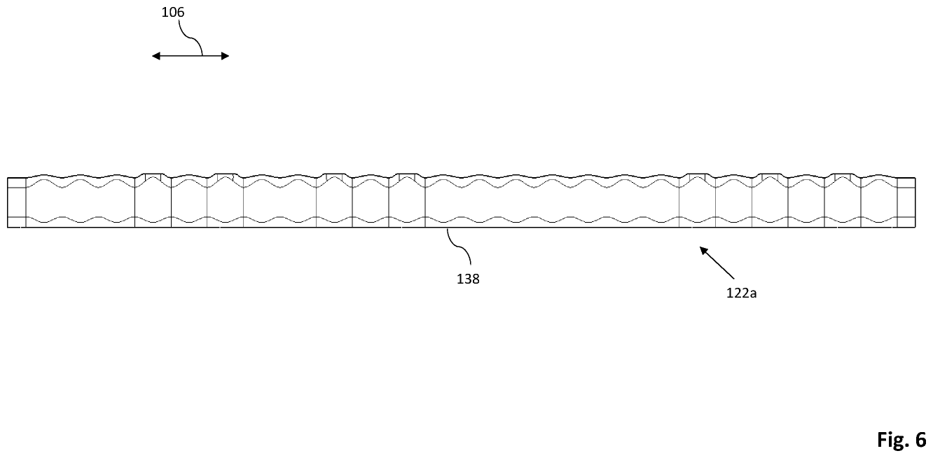

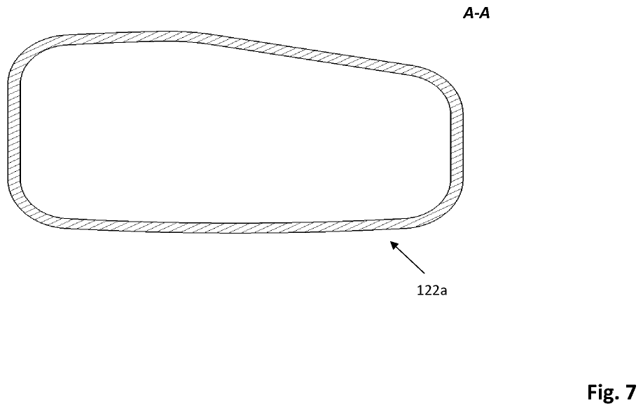

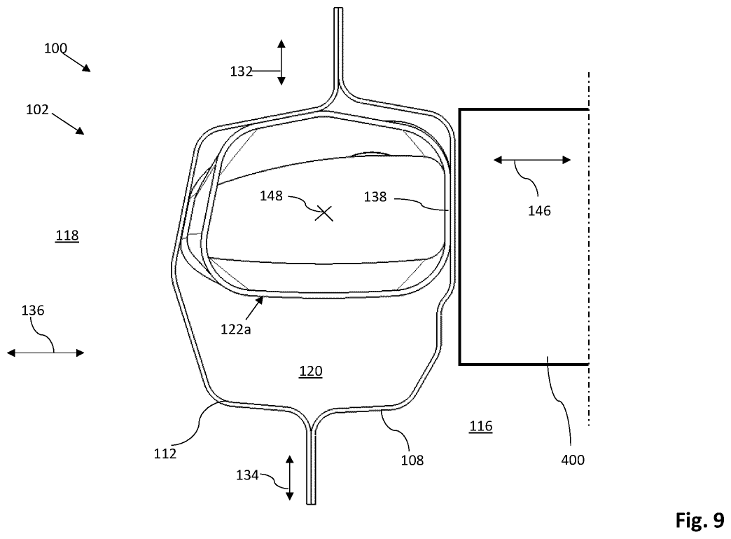

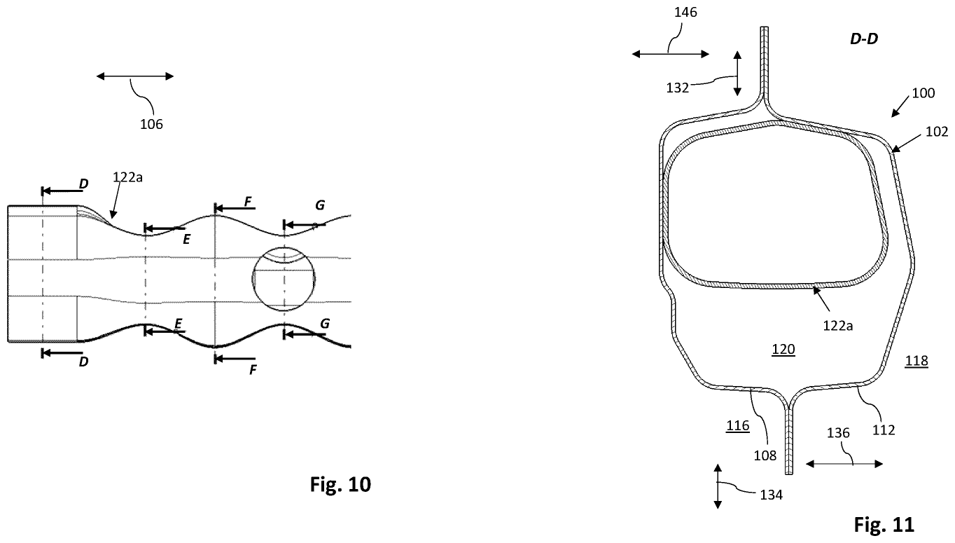

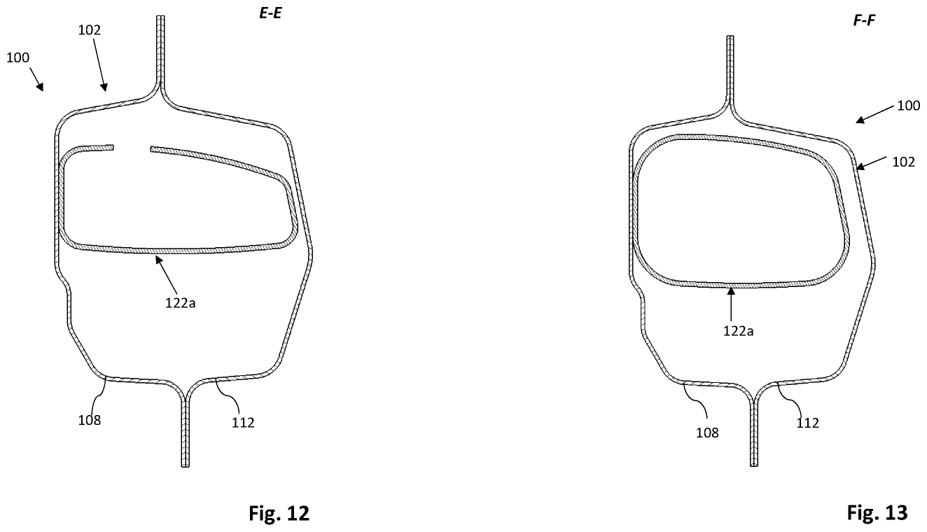

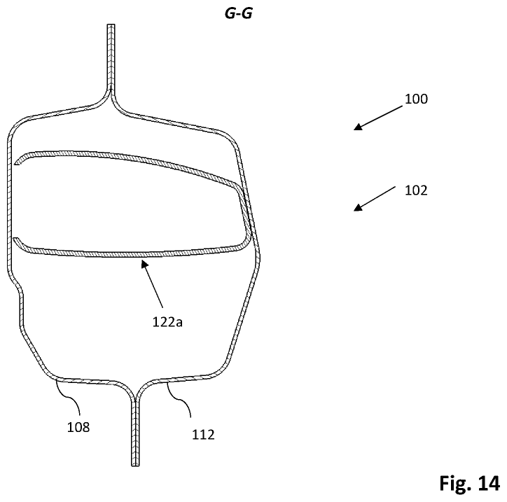

With reference to FIGS. 1 to 14, a first embodiment of the vehicle structure 100 according to the first aspect of the invention and aspects of embodiments of the vehicle structure according to the first aspect of the invention are schematically illustrated.

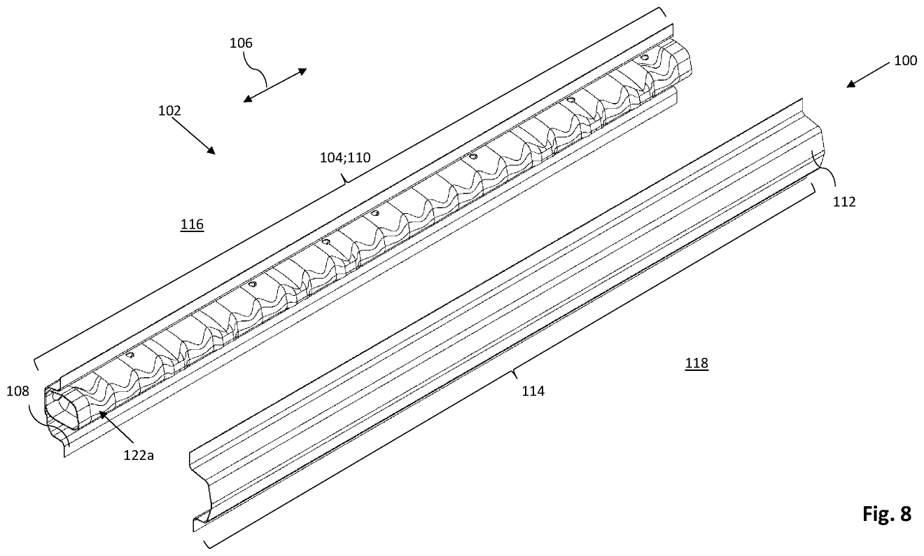

With reference to FIGS. 8 to 14, the vehicle structure 100 includes a portion 102 having a longitudinal extension 104 (see FIG. 8) extending in a longitudinal direction 106. The portion 102 includes a first member 108 having a longitudinal extension 110 extending in the longitudinal direction 106 (see FIG. 8). The portion 102 includes a second member 112 having a longitudinal extension 114 extending in the longitudinal direction 106 (see FIG. 8). The first member 108 is configured to face an inside 116 of a vehicle. The second member 112 is configured to face an outside 118 of the vehicle. The first and second members 108, 112 are attached to one another such that the first and second members 108, 112 form a closed space 120. Thus, when the vehicle structure 100 has been installed, the first member 108 may face the inside 116 of the vehicle while the second member 112 may face the outside 118 of the same vehicle.

A “closed space” 120 in the present disclosure also includes spaces which are substantially or essentially closed. For example, there may be one or more minor openings in the walls forming the closed space 120 and/or at the ends of the portion 102 of the vehicle structure 100, but still the space 120 is to be considered to be closed. For example, the first and second members 108, 112 may be attached to one another by welding, such as laser welding, spot welding, or continuous welding, a mechanical locking structure, such as rivets, an adhesive, or any other suitable fastening means.

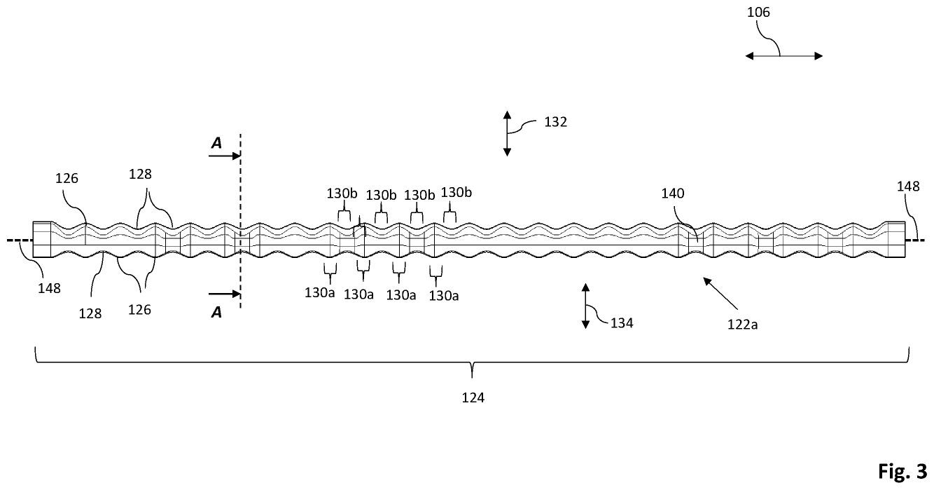

With reference to FIGS. 1 to 14, the portion 102 includes one or more tubular reinforcement members 122a located in the closed space 120. In the embodiment illustrated in FIGS. 8 to 14, the portion 102 includes one tubular reinforcement member 122a. However, for other embodiments, the portion 102 may include two or more tubular reinforcement members 122a. The tubular reinforcement member 122a has a longitudinal extension 124 (see FIG. 3) extending in the longitudinal direction 106. The tubular reinforcement member 122a is corrugated and comprises corrugations 126, 128 (see FIGS. 1, 3 and 5). For some embodiments, it may be defined that the corrugations 126, 128 comprise ridges 126 and grooves 128. For some embodiments, it may be defined that one or more of the ridges 126 and grooves 128 at least partially extends/extend transversely to the longitudinal direction 106.

With reference to FIGS. 1, 3, and 5, the tubular reinforcement member 122a includes two or more member sections 130a, 130b positioned after one another in the longitudinal direction 106. It may be described that the two or more member sections 130a, 130b are positioned after one another in series in the longitudinal direction 106. One 130a of the member sections 130a, 130b bulges outward in a first direction 132 (such as in an upward direction 132) and in a second direction 134 (such as in a downward direction 134) opposite to the first direction 132 and bulges inward in a third direction 136 (such as in a lateral direction 136), the third direction 136 being transverse to the first and second directions 132, 134, while another one 130b of the member sections 130a, 130b, which adjoins said one 130a of the member sections 130a, 130b, bulges inward in the first and second directions 132, 134 and bulges outward in the third direction 136. The fact that the two member sections 130a, 130b adjoins one another implies that the other one 130b of the member sections 130a, 130b lies next to, or is in contact with, said one 130a of the member sections 130a, 130b. For some embodiments, the tubular reinforcement member 122a may include five or more member sections 130a, 130b, for example ten or more member sections 130a, 130b, such as 15 or more member sections 130a, 130b, for example 20 or more member sections 130a, 130b, positioned after one another in the longitudinal direction 106.

For some embodiments, it may be defined, or described, that the corrugated tubular reinforcement member 122a forms two or more wave shapes, such as three or four wave shapes, that are shifted in relation to one another in the longitudinal direction 106, or in the direction of the longitudinal extension 124 of the tubular reinforcement member 122a, and/or that are not in phase with one another in the longitudinal direction 106. For some embodiments, it may be defined, or described, that the two or more wave shapes provide a zig-zag, or alternating, structure or appearance of the corrugated tubular reinforcement member 122a and/or of the member sections 130a, 130b adjoining one another, for example in the longitudinal direction 106. For some embodiments, it may be defined, or described, that the tubular reinforcement member 122a has two or more longitudinal sides, such as three or four longitudinal sides, and that one (or more) of the longitudinal sides of the tubular reinforcement member 122a bulges outward at a cross-section of the longitudinal extension 124 of the tubular reinforcement member 122a while another one (or two) of the longitudinal sides of the tubular reinforcement member 122a bulges inward at the same cross-section, and that at a subsequent cross-section in the longitudinal direction 106 it is the other way around. For some embodiments, it may be defined, or described, that in the longitudinal direction 106, or when viewed along the longitudinal sides of the tubular reinforcement member 122a in the longitudinal direction 106, the wave shape of one of the longitudinal sides of the tubular reinforcement member 122a is displaced in the longitudinal direction 106 in relation to the wave shape of another one (or two) of the longitudinal sides of the tubular reinforcement member 122a, such as another adjacent longitudinal side, or two other adjacent longitudinal sides of the longitudinal sides.

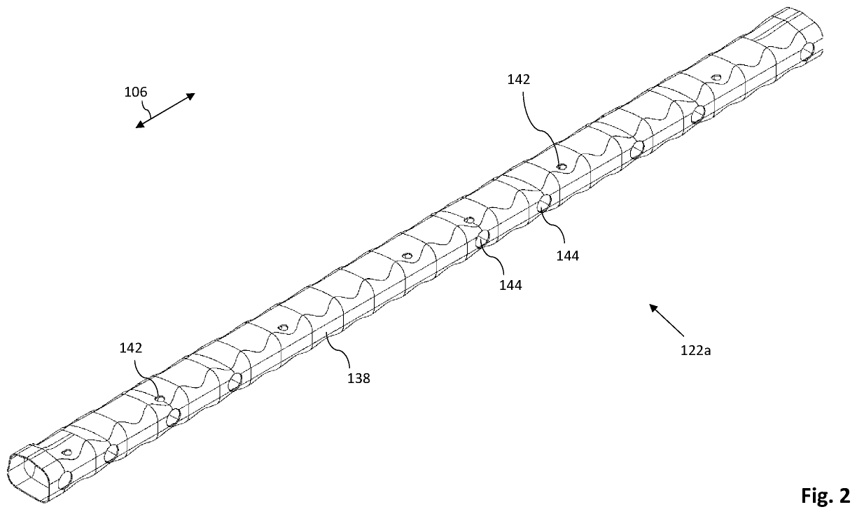

With reference to FIGS. 2, 4, and 5, for some embodiments, the tubular reinforcement member 122a may include one or more flat regions 138 extending along substantially the entire longitudinal extension 124 of the tubular reinforcement member 122a. In the embodiment illustrated in FIGS. 1 to 14, the tubular reinforcement member 122a includes one flat region 138 extending along substantially the entire longitudinal extension 124 of the tubular reinforcement member 122a. However, for other embodiments, the tubular reinforcement member 122a may include two or more flat regions, for example spaced apart. For some embodiments, the flat region 138 may be used for the attachment of the tubular reinforcement member 122a to one 108, 112 of the first and second members 108, 112, for example by way of welding, such as laser welding, spot welding, or continuous welding, a mechanical locking structure, such as rivets, an adhesive, or any other suitable fastening means. For some embodiments, in addition to or instead of the flat region 138 mentioned above, the tubular reinforcement member 122a may include one or more flat, or planar, regions 140, for example outside the flat region 138 mentioned above, for the attachment of the tubular reinforcement member 122a to one or more of the first and second members 108, 112, for example by way of welding, such as laser welding, or spot welding, a mechanical locking structure, such as rivets, an adhesive, or any other suitable fastening means.

With reference to FIGS. 1 to 14, for some embodiments, the member sections 130a, 130b may form one or more wave shapes extending along the longitudinal extension 124 of the tubular reinforcement member 122a in the longitudinal direction 106. For some embodiments, it may be defined that the member sections 130a, 130b form, or build up, the tubular reinforcement member 122a.

With reference to FIGS. 1, 2, 4 and 5, for some embodiments, the tubular reinforcement member 122a may form one or more openings 142, 144 for welding so as to attach the tubular reinforcement member 122a to one or more of the first and second members 108, 112, for example by laser welding, or spot welding. The opening 142, 144 may be located at one of the two end portions of the tubular reinforcement member 122a, or at any position between the two end portions of the tubular reinforcement member 122a.

With reference to FIGS. 1 to 14, for some alternative embodiments, instead of the flat region 138 extending along the entire longitudinal extension 124 of the tubular reinforcement member 122a, one 130a of the member sections 130a, 130b bulges outward in the first and second directions 132, 134 and bulges inward in the third direction 136 and in a fourth direction 146 (such as in another lateral direction 146) opposite to the third direction 136 while another one 130b of the member sections 130a, 130b, which adjoins said one 130a of the member sections 130a, 130b, bulges inward in the first and second directions 132, 134 and bulges outward in the third and fourth directions 136, 146. For some of the alternative embodiments, the corrugations 126, 128 of the tubular reinforcement member 122a may comprise annular ridges, wherein one 130a of the member sections 130a, 130b and said other one 130b of the member sections 130a, 130b, which bulge outward and inward, together comprise one and the same annular ridge of the annular ridges. The annular ridge may at least partially extend transversely to the longitudinal direction 106. For some of the alternative embodiments, the corrugations 126, 128 of the tubular reinforcement member 122a may comprise annular grooves, wherein said one 130a of the member sections 130a, 130b and said other one 130b of the member sections 130a, 130b, which bulge outward and inward, together comprise one and the same annular groove of the annular grooves. The annular groove may at least partially extend transversely to the longitudinal direction 106. The annular ridges and the annular grooves may form one or more wave shapes extending along the longitudinal extension 124 of the tubular reinforcement member 122a in the longitudinal direction 106. The annular ridges and the annular grooves may form the tubular reinforcement member 122a. For some of the alternative embodiments without the flat region 138, the tubular reinforcement member 122a may still include one or more of said flat regions 140 for the attachment of the tubular reinforcement member 122a to one or more of the first and second members 108, 112.

With reference to FIGS. 1, 3 and 9, the longitudinal extension 124 of the tubular reinforcement member 122a may be described to extend in a direction 106 of a longitudinal central axis 148 surrounded by the tubular reinforcement member 122a. The three or four directions 132, 134, 136, 146 may be related, or in relation, to the longitudinal central axis 148. “Outward” and “inward” mentioned above may be in relation to the longitudinal central axis 148. “Outward” may be in a direction away from the longitudinal central axis 148 while “inward” may be in a direction toward the longitudinal central axis 148.

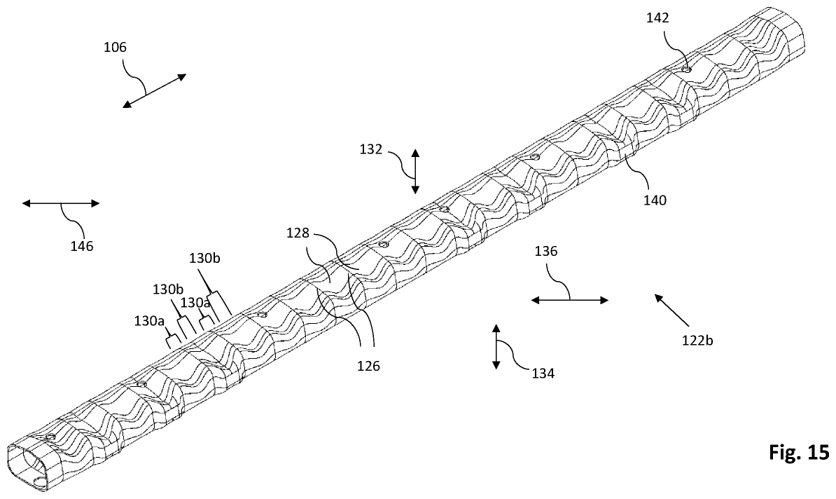

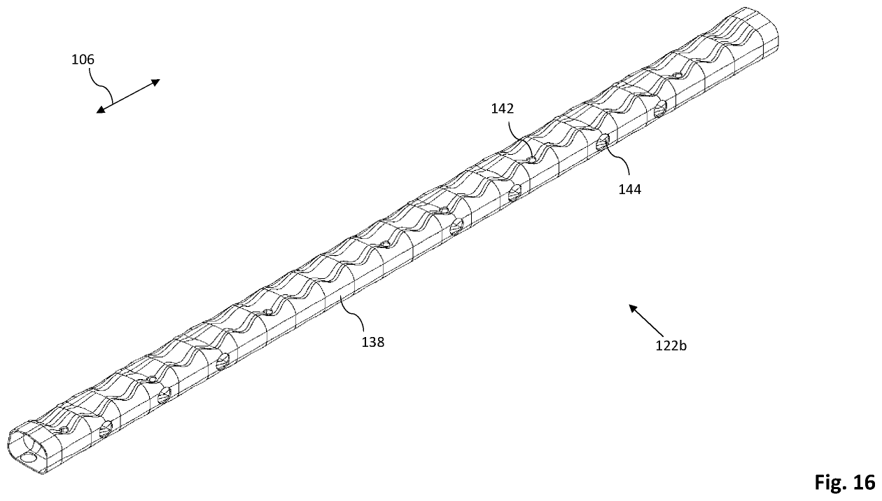

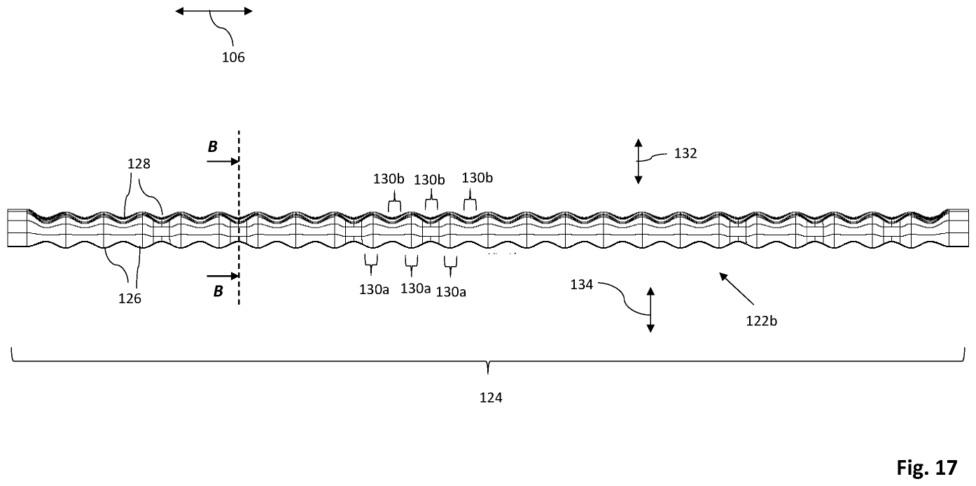

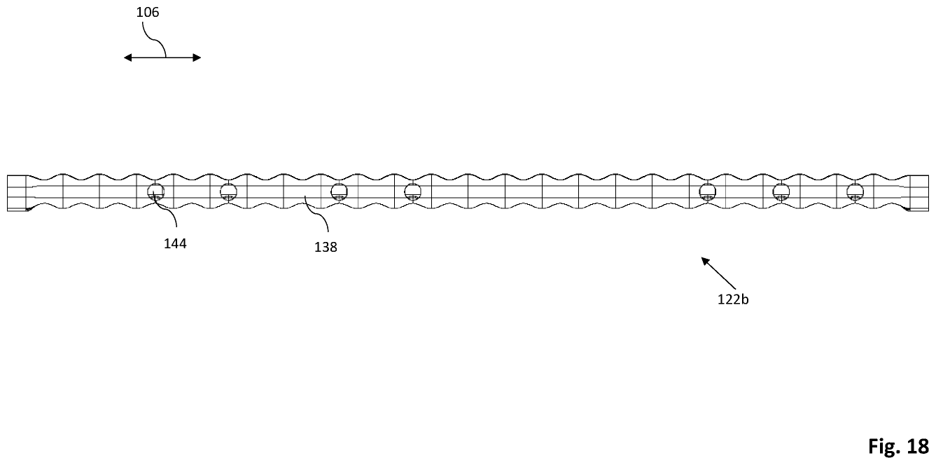

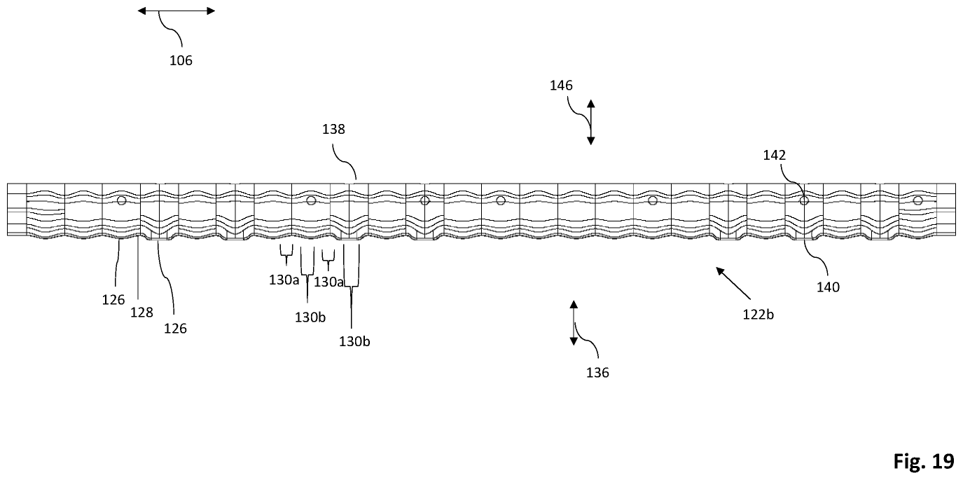

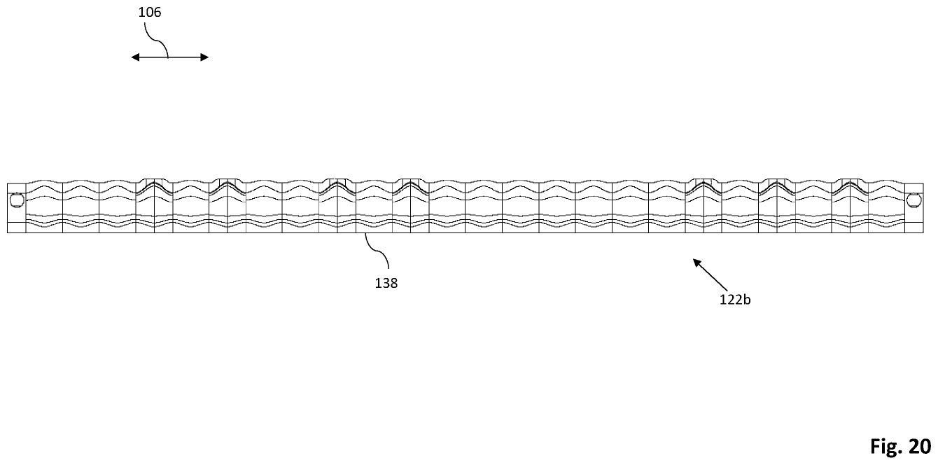

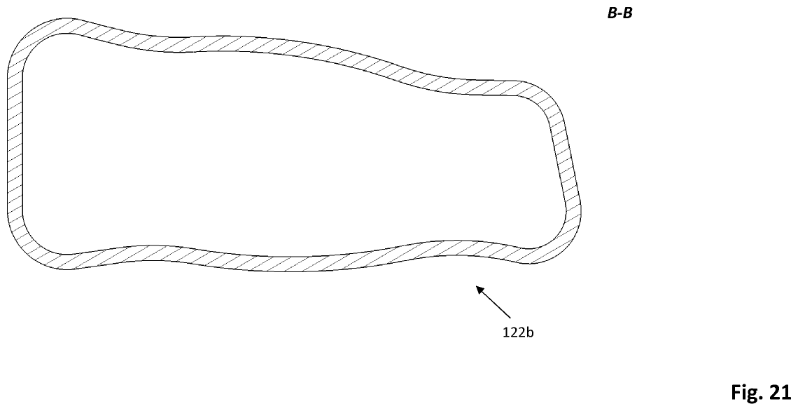

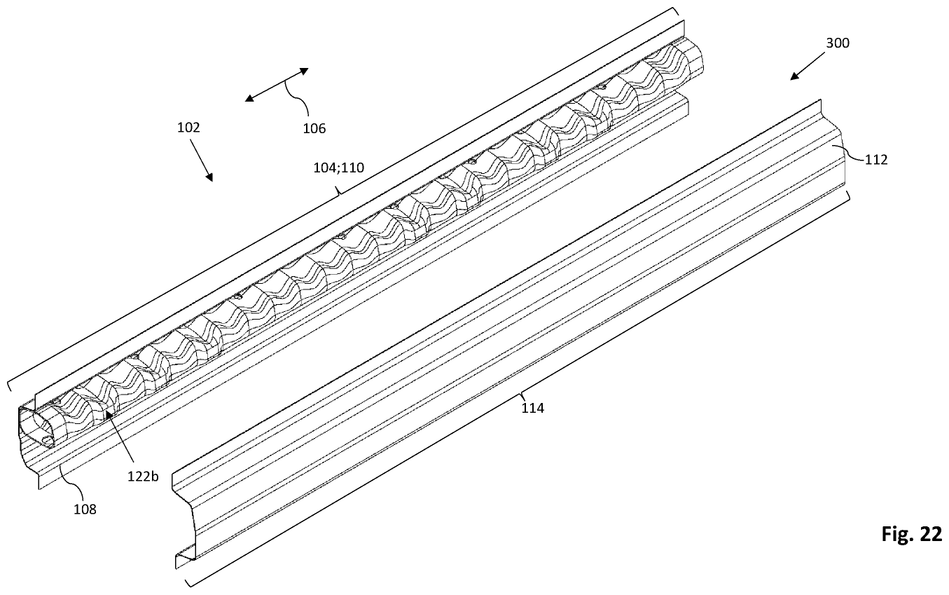

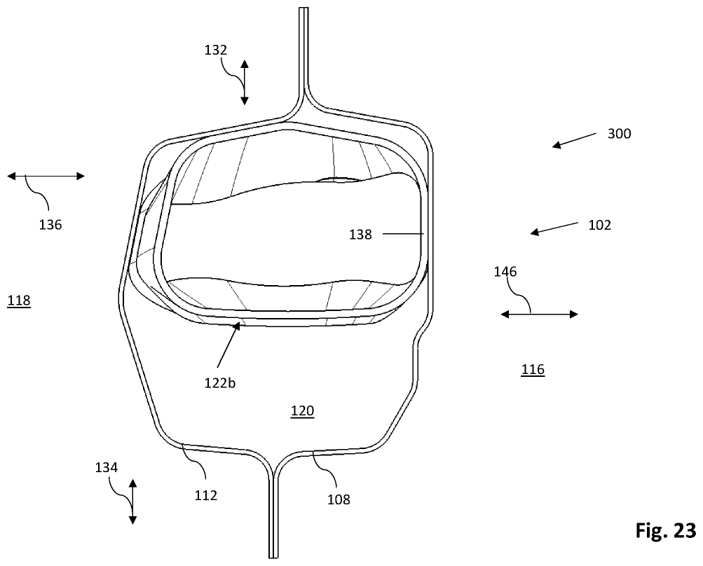

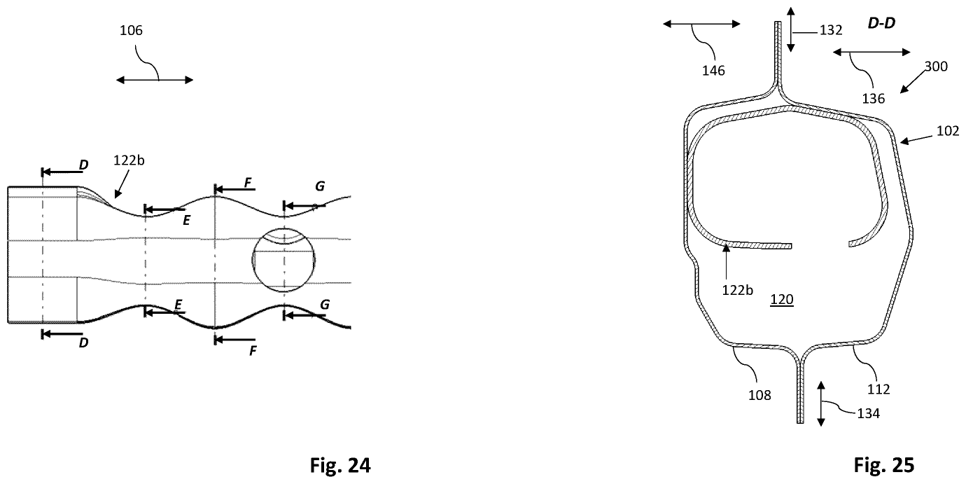

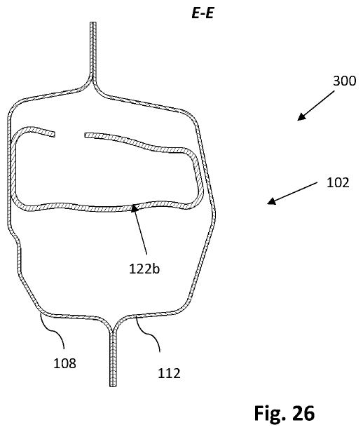

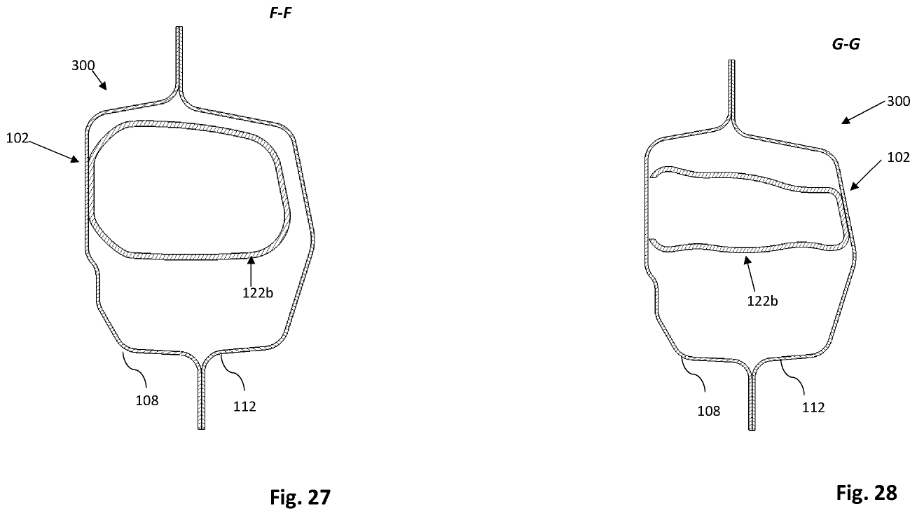

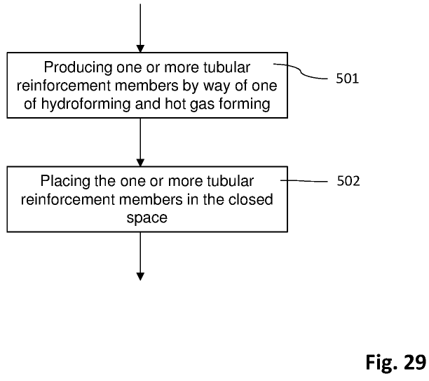

With reference to FIGS. 15 to 28, a second embodiment of the vehicle structure 300 according to the first aspect of the invention and further aspects of embodiments of the vehicle structure according to the first aspect of the invention are schematically illustrated. Several features of the second embodiment of the vehicle structure 300 may correspond to features of the first embodiment of the vehicle structure 100 of FIGS. 1 to 14 and are thus not repeated here to avoid repetition. The vehicle structure 300 of FIGS. 15 to 28 differs from the vehicle structure 100 of FIGS. 1 to 14 in that it has modified tubular reinforcement member 122b wherein one 130a of the member sections 130a, 130b bulges outward and inward in the first and second directions 132, 134 and bulges inward in the third direction 136 while another one 130b of the member sections 130a, 130b, which adjoins said one 130a of the member sections 130a, 130b, bulges inward and outward in the first and second directions 132, 134 and bulges outward in the third direction 136. For some alternative embodiments, instead of the flat region 138 extending along the entire longitudinal extension 124 of the tubular reinforcement member 122b, one 130a of the member sections 130a, 130b bulges outward and inward in the first and second directions 132, 134 and bulges inward in the third and fourth directions 136, 146 while another one 130b of the member sections 130a, 130b, which adjoins said one 130a of the member sections 130a, 130b, bulges inward and outward in the first and second directions 132, 134 and bulges outward in the third and fourth directions 136, 146.

For some embodiments, it may be described that when the member section 130a, 130b bulges inward, a groove 128 is formed. It may be described that when the member section 130a, 130b bulges outward, a ridge 126 is formed.

With reference to FIGS. 1 to 28, for some embodiments, the tubular reinforcement member 122a-b may be hydroformed, hot gas formed, extruded, formed from one or more plates, formed from one or more plates by way of hot press forming, or formed from one or more plates by way of cold working. However, other ways to produce the tubular reinforcement member 122a-b are possible. For some embodiments, the tubular reinforcement member 122a-b may be made of a material comprising or consisting of a metal or a metal alloy, for example aluminium, or steel, or a material including aluminium or steel. For some embodiments, the tubular reinforcement member 122a-b may be made of a material comprising or consisting of a polymer or a polymer composite, such as a fibre reinforced polymer, for example a carbon fibre reinforced polymer (CFRP). However, other materials are possible. One or more of the first and second members 108, 112 may be formed from a plate, formed from one or more plates by way of hot press forming, or formed from one or more plates by way of cold working. One or more of the first and second members 108, 112 may be made of a material comprising or consisting of a metal or a metal alloy, for example aluminium. However, other materials are possible. For some embodiments, one or more of the first and second members 108, 112 may comprise one of the group of: a hat profile; and a U-profile.

For some embodiments, the following types of material may be used for one or more of the tubular reinforcement members 122a-b and first and second members 108, 112, or for any other element or member included in the vehicle structure 100; 300:

There are several known Ultra High Strength steels (UHSS) for hot stamping and hardening. The blank may be made e.g. of a boron steel, coated or uncoated, such as Usibor® (22MnB5) commercially available from ArcelorMittal.

Usibor® 1500P is an example of a 22MnB5 steel. The composition of Usibor® is summarized below in weight percentages (rest is iron (Fe) and unavoidable impurities):
Maximum carbon (C) (%): 0.25
Maximum silicon (Si) (%): 0.4
Maximum manganese (Mn) (%): 1.4
Maximum phosphorus (P) (%): 0.03
Maximum sulphur(S) (%): 0.01
Aluminium (Al) (%): 0.01-0.1
Maximum titanium (Ti) (%): 0.05
Maximum niobium (Nb) (%): 0.01
Maximum copper (Cu) (%): 0.20
Maximum boron (B) (%): 0.005
Maximum chromium (Cr) (%): 0.35.

Usibor® 1500P may have a yield strength of e.g. 1100 MPa, and an ultimate tensile strength of 1500 MPa.

Usibor® 2000 is another boron steel with even higher strength. The yield strength of Usibor® 2000 may be 1400 MPa or more, and the ultimate tensile strength may be above 1800 MPa. The composition of Usibor® 2000 is summarized below in weight percentages (rest is iron (Fe) and impurities):
Maximum carbon (C) (%): 0.36
Maximum silicon (Si) (%): 0.8
Maximum manganese (Mn) (%): 0.8
Maximum phosphorus (P) (%): 0.03
Maximum sulphur(S) (%): 0.01
Aluminium (Al) (%): 0.01-0.06
Maximum titanium (Ti) (%): 0.07
Maximum niobium (Nb) (%): 0.07
Maximum copper (Cu) (%): 0.20
Maximum boron (B) (%): 0.005
Maximum chromium (Cr) (%): 0.50
Maximum molybdenum (Mb) (%): 0.50.

In addition to the Ultra High Strength Steels mentioned before, more ductile steels may also be used in parts of the structural skeleton requiring energy absorption. These steels may be used in hot stamping processes but will not obtain a martensitic microstructure in the process. Examples of suitable, more ductile steels include Ductibor® 500, Ductibor® 1000 and CRL-340LA.

Another material used in hot stamping is Ductibor® 500. Ductibor® 500 is a steel material with much higher ductility and these can be effective for absorbing energy during an impact. The yield strength of Ductibor® 500 may be 400 MPa or more, and the ultimate tensile strength of 550 MPa or more.

The composition of Ductibor® 500 is summarized below in weight percentages (rest is iron (Fe) and impurities):
Maximum carbon (C) (%): 0.1
Maximum silicon (Si) (%): 0.5
Maximum manganese (Mn) (%): 1.7
Maximum phosphorus (P) (%): 0.03
Maximum sulphur(S) (%): 0.025
Aluminium (Al) (%): 0.015-0.2
Maximum titanium (Ti) (%): 0.09
Maximum niobium (Nb) (%): 0.10
Maximum copper (Cu) (%): 0.20.
Maximum boron (B) (%): 0.001
Maximum chromium (Cr) (%): 0.20.

Ductibor® 1000 is another material used in hot stamping for increasing the elongation if compared to Usibor® 1500 and Usibor® 2000. The yield strength of Ductibor® 1000 may be 800 MPa or more, and the ultimate tensile strength of 1000 MPa or more. The composition of Ductibor® 1000 is summarized below in weight percentages (rest is iron (Fe) and impurities):
Maximum carbon (C) (%): 0.10
Maximum silicon (Si) (%): 0.6
Maximum manganese (Mn) (%): 1.8
Maximum phosphorus (P) (%): 0.03
Maximum sulphur(S) (%): 0.01
Aluminium (Al) (%): 0.01-0.1
Maximum titanium (Ti) (%): 0.05
Maximum niobium (Nb) (%): 0.10
Maximum copper (Cu) (%): 0.20
Maximum boron (B) (%): 0.005
Maximum chromium (Cr) (%): 0.20.

Each of the vehicle structures 100, 300 described above may be a vehicle side structure, and the respective portion 102 may be a side portion. However, the vehicle structure 100, 300 may be applied and mounted elsewhere to the vehicle, for example in the front of the vehicle, and may there be part of a bumper, in the rear of the vehicle, or elsewhere within the vehicle. The vehicle structure 100, 300 may for example be used in an electric vehicle or a hybrid vehicle, but of course also in a regular vehicle with a combustion engine only. The vehicle structure 100, 300 may be configured to protect one or more electric batteries of an electric vehicle or a hybrid vehicle, for example upon a collision. Thus, the vehicle structure 100, 300 may be located at one or more sides of the electric battery. The vehicle structure 100, 300 is efficient in protecting the driver and/or one or more passengers of the vehicle upon a collision. The vehicle structure 100, 300 is efficient as a protection with regard to pole collisions or crashes. The vehicle structure 100, 300 is efficient in preventing the intrusion of a pole into the car upon a pole collision.

For some embodiments, the portion 102 is a side sill portion, wherein the longitudinal extension 104 of the side sill portion 102 is configured to extend in a longitudinal direction 106 of a vehicle body of the vehicle and is configured to be provided at a side of the vehicle body. With reference to FIG. 9, for some embodiments, the side sill portion 102 may be configured to be attached, or be attachable, to one or more cross beams 400 of the vehicle body, for example two cross beams of the vehicle body. However, in alternative embodiments, instead of a side sill portion, the portion or the side portion may be a side beam portion, a bumper portion, or a beam portion configured to be located elsewhere in a vehicle.

The features of the different embodiments of the vehicle structure disclosed above may be combined in various possible ways providing further advantageous embodiments.

With reference to FIG. 29, aspects of embodiments of the method for producing a vehicle structure 100, 300 comprising a portion 102 having a longitudinal extension extending in a longitudinal direction 104 according to the second aspect of the invention are schematically illustrated in a flow chart, wherein the portion 102 includes
a first member 108 having a longitudinal extension 110 extending in the longitudinal direction 106, and
a second member 112 having a longitudinal extension 114 extending in the longitudinal direction 106,
wherein the first member 108 is configured to face an inside 116 of a vehicle,
wherein the second member 112 is configured to face an outside 118 of the vehicle,
wherein the first and second members 108, 112 are attached to one another such that the first and second members 108, 112 form a closed space 120,
wherein the method comprises:
producing 501 one or more tubular reinforcement members 122a-b by way of one of hydroforming and hot gas forming; and
placing 502 the one or more tubular reinforcement members 122a-b in the closed space 120.

The present invention is not limited to the above-described embodiments. Instead, the present invention relates to, and encompasses all different embodiments being Included within the scope of the appended independent claims.

1. A vehicle structure comprising a portion having a longitudinal extension extending in a longitudinal direction, wherein the portion comprises
a first member having a longitudinal extension extending in the longitudinal direction, and
a second member having a longitudinal extension extending in the longitudinal direction,
wherein the first member is configured to face an inside of a vehicle,
wherein the second member is configured to face an outside of the vehicle,
wherein the first and second members are attached to one another such that the first and second members form a closed space,
wherein the portion comprises one or more tubular reinforcement members located in the closed space,
wherein the tubular reinforcement member has a longitudinal extension extending in the longitudinal direction,
wherein the tubular reinforcement member is corrugated and comprises corrugations,
wherein the tubular reinforcement member comprises two or more member sections positioned after one another in the longitudinal direction, and
wherein one of the member sections bulges outward in a first direction and in a second direction opposite to the first direction and bulges inward in a third direction, the third direction being transverse to the first and second directions, while another one of the member sections, which adjoins said one of the member sections, bulges inward in the first and second directions and bulges outward in the third direction.

2. The vehicle structure according to claim 1, wherein the tubular reinforcement member comprises one or more flat regions extending along the entire longitudinal extension of the tubular reinforcement member.

3. The vehicle structure according to claim 1, wherein one of the member sections bulges outward and inward in the first and second directions and bulges inward in the third direction while another one of the member sections, which adjoins said one of the member sections, bulges inward and outward in the first and second directions and bulges outward in the third direction.

4. The vehicle structure according to claim 1, wherein one of the member sections bulges outward in the first and second directions and bulges inward in the third direction and in a fourth direction opposite to the third direction while another one of the member sections, which adjoins said one of the member sections, bulges inward in the first and second directions and bulges outward in the third and fourth directions.

5. The vehicle structure according to claim 4, wherein the corrugations of the tubular reinforcement member comprise annular ridges, and
wherein said one of the member sections and said other one of the member sections, which bulge outward and inward, together comprise one and the same annular ridge of the annular ridges.

6. The vehicle structure according to claim 5, wherein the annular ridge at least partially extends transversely to the longitudinal direction.

7. The vehicle structure according to claim 4, wherein the corrugations of the tubular reinforcement member comprise annular grooves, and
wherein said one of the member sections and said other one of the member sections, which bulge outward and inward, together comprise one and the same annular groove of the annular grooves.

8. The vehicle structure according to claim 7, wherein the annular groove at least partially extends transversely to the longitudinal direction.

9. The vehicle structure according to claim 7, wherein the annular ridges and the annular grooves form one or more wave shapes extending along the longitudinal extension of the tubular reinforcement member in the longitudinal direction.

10. The vehicle structure according to any claim 4, wherein one of the member sections bulges outward and inward in the first and second directions and bulges inward in the third and fourth directions while another one of the member sections, which adjoins said one of the member sections, bulges inward and outward in the first and second directions and bulges outward in the third and fourth directions.

11. The vehicle structure according to claim 4, wherein the tubular reinforcement member comprises one or more flat regions for the attachment of the tubular reinforcement member to one or more of the first and second members.

12. The vehicle structure according to claim 1, wherein the member sections form one or more wave shapes extending along the longitudinal extension of the tubular reinforcement member in the longitudinal direction.

13. The vehicle structure according to claim 1, wherein the tubular reinforcement member forms one or more openings for welding so as to attach the tubular reinforcement member to one or more of the first and second members.

14. The vehicle structure according to claim 1, wherein the tubular reinforcement member is hydroformed, hot gas formed, extruded, or formed from one or more plates.

15. A method for producing a vehicle structure comprising a portion having a longitudinal extension extending in a longitudinal direction, wherein the portion comprises
a first member having a longitudinal extension extending in the longitudinal direction, and
a second member having a longitudinal extension extending in the longitudinal direction,
wherein the first member is configured to face an inside of a vehicle,
wherein the second member is configured to face an outside of the vehicle,
wherein the first and second members are attached to one another such that the first and second members form a closed space,
wherein the method comprises:
producing one or more tubular reinforcement members by way of one of hydroforming and hot gas forming; and
placing the one or more tubular reinforcement members in the closed space.
